(19) United States
(12) Patent Application Publication
(10) Pub. No.: US 2008/0100694 A1
(43) Pub. Date: May 1, 2008

(54) Distributed caching for multimedia conference calls

(75) Inventors: Warren V. Barkley, Redmond, WA (US); Philip A. Chou, Redmond, WA (US); Regis J. Crinon, Redmond, WA (US); Tim Moore, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/588,708

(22) Filed: Oct. 27, 2006

(51) Int. Cl. H04N 7/14

(52) U.S. Cl. 348/14.08

(57) ABSTRACT

Techniques to perform distributed caching for multimedia conference calls are described. An apparatus may comprise a conferencing server and a frame management module. The conferencing server may receive a sequence of video frames from a sending client terminal and send the sequence of video frames to multiple receiving client terminals. The frame management module may receive a client frame request for one of the video frames from a receiving client terminal, retrieve the requested video frame, and send the requested video frame in response to the client frame request. Other embodiments are described and claimed.

### BACKGROUND

Multimedia conference calls typically involve communicating voice, video, and/or data information between multiple endpoints. With the proliferation of data networks, multimedia conferencing is migrating from traditional circuit-switched networks to packet networks. To establish a multimedia conference call over a packet network, a conferencing server typically operates to coordinate and manage the conference call. The conferencing server receives a video stream from a sending participant and multicasts the video stream to other participants in the conference call.

During multicast operations, there may be occasions when portions of the video stream may need to be retransmitted for various reasons. For example, sometimes one or more video frames are lost during transmission. In this case, the receiving participant may request a resend of the lost video frame or entire video frame sequence from the sending participant. Similarly, when a new receiving participant joins a conference call, the new receiving participant may request the sending participant to retransmit the latest sequence of video frames. Both scenarios may unnecessarily burden computing and memory resources for the sending participant. In the latter case, an alternative solution might have the new receiving participant wait until the sending participant sends the next sequence of video frames. This solution, however, potentially causes the new receiving participant to experience various amounts of unnecessary delay when joining the conference call. Accordingly, improved techniques to solve these and other problems may be needed for multimedia conference calls.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments may be generally directed to multimedia conferencing systems. Some embodiments in particular may be directed to techniques for distributed caching of video information for a multimedia conference call system to facilitate retransmission of video frames in response to various retransmission events, such as lost or missing video frames, a new participant joining the conference call, and so forth. In one embodiment, for example, a multimedia conferencing system may include a conferencing server and multiple client terminals. The conferencing server may be arranged to receive a sequence of video frames from a sending client terminal, and reflect or send the sequence of video frames to multiple receiving client terminals participating in the multimedia conference call.

In various embodiments, a conferencing server may further include a frame management module arranged to receive a client frame request for one of the video frames (or a portion of the video frame such as a slice) from a receiving client terminal. The frame management module may retrieve the requested video frames, and send the requested video frames in response to the client frame request to the receiving client terminal that initiated the request. For example, the frame management module may retrieve the requested video frames from a memory unit implemented with the conferencing server to store the latest video frame or sequence of video frames, or from another receiving client terminal having memory units to store the latest video frame or sequence of video frames. In this manner, retransmission operations may be performed by other elements of a multimedia conferencing system in addition to, or in lieu of, the sending client terminal. Other embodiments are described and claimed.

### BRIEF DESCRIPTION OF THE DRAWINGS

FIG. 1 illustrates an exemplary embodiment of a conferencing system.

FIG. 2 illustrates an exemplary embodiment of a conferencing server.

FIG. 3 illustrates an exemplary embodiment of a logic flow.

FIG. 4 illustrates an exemplary embodiment of a first message flow.

FIG. 5 illustrates an exemplary embodiment of a second message flow.

FIG. 6 illustrates an exemplary embodiment of a third message flow.

FIG. 7 illustrates an exemplary embodiment of a fourth message flow.

FIG. 8 illustrates an exemplary embodiment of a fifth message flow.

FIG. 9 illustrates an exemplary embodiment of a sixth message flow.

FIG. 10 illustrates an exemplary embodiment of a seventh message flow.

FIG. 11 illustrates an exemplary embodiment of an eighth message flow.

### DETAILED DESCRIPTION

Various embodiments may be directed to techniques for distributed caching of video information for a multimedia conference system to facilitate retransmission of video frames in response to various retransmission events. In one embodiment, for example, a conferencing server may reflect video streams from a sending client terminal to multiple receiving client terminals. A video stream or bit stream is typically comprised of multiple, consecutive group of picture (GOP) structures comprising several different types of encoded video frames, such as an Intra (I) frame (I-frame), a Predictive (P) frame (P-frame), a Super Predictive (SP) frame (SP-frame), and a Bi-Predictive or Bi-Directional (B) frame (B-frame). Once the transmission of a video stream has been initiated, a retransmission event may occur necessitating a retransmission of one or more video frames in a video frame sequence (e.g., GOP). Typically, the video frame needed for retransmission is an I-frame since it is used to decode other frames in the video frame sequence, although other video frames may be need retransmission as well. Various embodiments may cache certain video frames from a video stream throughout one or more elements of a multimedia conference system to facilitate retransmission operations. For example, caching techniques may be implemented in a conferencing server or receiving client terminal. In another example, distributed caching techniques may be implemented among the conferencing server and one or more receiving client terminals to distribute memory and processing demands or provide data redundancy. A frame management module may be implemented to manage, coordinate and/or otherwise facilitate retransmission of video frames to one or more receiving client terminals from a conferencing server or one or more receiving client terminals.

It is worthy to note that the term “frame” as used herein may refer to any defined set of data or portion of data, such as a data set, a cell, a fragment, a data segment, a packet, an image, a picture, and so forth. As used herein, the term “frame” may refer to a snapshot of the media information at a given point in time. Further, some embodiments may be arranged to communicate frames of information, such as media information (e.g., audio, video, images, and so forth). Such communication may involve communicating the actual frames of information, as well as various encodings for the frames of information. For example, media systems typically communicate encodings for the frames rather than the actual frame itself. Consequently, an “I-frame” or “P-frame” typically refers to an encoding of a frame rather than the frame itself. A frame could be sent to one client as a P-frame, and the same frame could be sent to another client (or to the same client, at a later time) as an I-frame, for example. Accordingly, communicating (or transmitting or re-transmitting) a frame of information may refer to both communicating the actual frame and/or an encoding for the actual frame. The embodiments are not limited in this context.

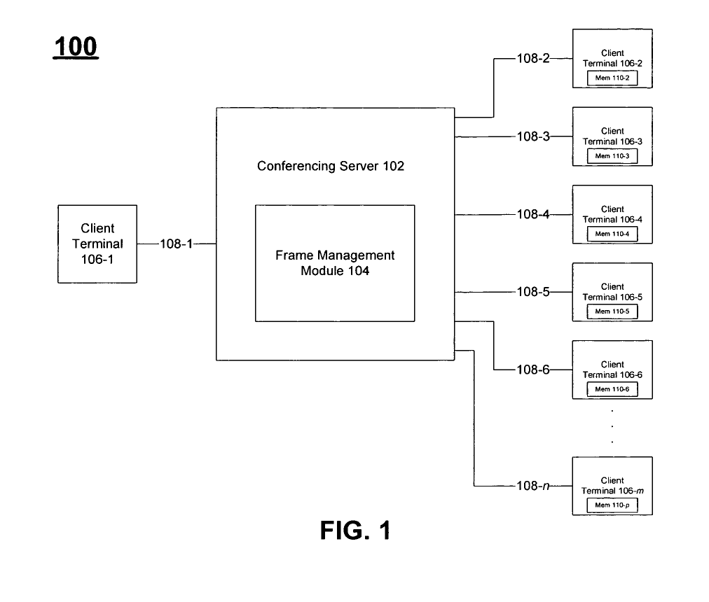

FIG. 1 illustrates a block diagram for a multimedia conferencing system 100. Multimedia conferencing system 100 may represent a general system architecture suitable for implementing various embodiments. Multimedia conferencing system 100 may comprise multiple elements. An element may comprise any physical or logical structure arranged to perform certain operations. Each element may be implemented as hardware, software, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although multimedia conferencing system 100 as shown in FIG. 1 has a limited number of elements in a certain topology, it may be appreciated that multimedia conferencing system 100 may include more or less elements in alternate topologies as desired for a given implementation. The embodiments are not limited in this context.

In various embodiments, multimedia conferencing system 100 may be arranged to communicate, manage or process different types of information, such as media information and control information. Examples of media information may generally include any data representing content meant for a user, such as voice information, video information, audio information, image information, textual information, numerical information, alphanumeric symbols, graphics, and so forth. Control information may refer to any data representing commands, instructions or control words meant for an automated system. For example, control information may be used to route media information through a system, to establish a connection between devices, instruct a device to process the media information in a predetermined manner, and so forth. It is noted that while some embodiments may be described specifically in the context of selectively removing video frames from video information to reduce video bit rates, various embodiments encompasses the use of any type of desired media information, such as pictures, images, data, voice, music or any combination thereof.

In various embodiments, multimedia conferencing system 100 may include a conferencing server 102. Conferencing server 102 may comprise any logical or physical entity that is arranged to manage or control a multimedia conference call between client terminals 106-1-m. In various embodiments, conferencing server 102 may comprise, or be implemented as, a processing or computing device, such as a computer, a server, a router, a switch, a bridge, and so forth. A specific implementation for conferencing server 102 may vary depending upon a set of communication protocols or standards to be used for conferencing server 102. In one example, conferencing server 102 may be implemented in accordance with the International Telecommunication Union (ITU) H.323 series of standards and/or variants. The H.323 standard defines a multipoint control unit (MCU) to coordinate conference call operations. In particular, the MCU includes a multipoint controller (MC) that handles H.245 signaling, and one or more multipoint processors (MP) to mix and process the data streams. In another example, conferencing server 102 may be implemented in accordance with the Internet Engineering Task Force (IETF) Multiparty Multimedia Session Control (MMUSIC) Working Group Session Initiation Protocol (SIP) series of standards and/or variants. SIP is a proposed standard for initiating, modifying, and terminating an interactive user session that involves multimedia elements such as video, voice, instant messaging, online games, and virtual reality. Both the H.323 and SIP standards are essentially signaling protocols for Voice over Internet Protocol (VoIP) or Voice Over Packet (VOP) multimedia conference call operations. It may be appreciated that other signaling protocols may be implemented for conferencing server 102, however, and still fall within the scope of the embodiments. The embodiments are not limited in this context.

In various embodiments, multimedia conferencing system 100 may include one or more client terminals 106-1-m to connect to conferencing server 102 over one or more communications links 108-1-n, where m and n represent positive integers that do not necessarily need to match. For example, a client application may host several client terminals each representing a separate conference at the same time. Similarly, a client application may receive multiple media streams. For example, video streams from all or a subset of the participants may be displayed as a mosaic on the participant's display with a top window with video for the current active speaker, and a panoramic view of the other participants in other windows. Client terminals 106-1-m may comprise any logical or physical entity that is arranged to participate or engage in a multimedia conference call managed by conferencing server 102. Client terminals 106-1-m may be implemented as any device that includes, in its most basic form, a processing system including a processor and memory (e.g., memory units 110-1-p), one or more multimedia input/output (I/O) components, and a wireless and/or wired network connection. Examples of multimedia I/O components may include audio I/O components (e.g., microphones, speakers), video I/O components (e.g., video camera, display), tactile (I/O) components (e.g., vibrators), user data (I/O) components (e.g., keyboard, thumb board, keypad, touch screen), and so forth. Examples of client terminals 106-1-m may include a telephone, a VoIP or VOP telephone, a packet telephone designed to operate on a Packet Switched Telephone Network (PSTN), an Internet telephone, a video telephone, a cellular telephone, a personal digital assistant (PDA), a combination cellular telephone and PDA, a mobile computing device, a smart phone, a one-way pager, a two-way pager, a messaging device, a computer, a personal computer (PC), a desktop computer, a laptop computer, a notebook computer, a handheld computer, a network appliance, and so forth. The embodiments are not limited in this context.

Depending on a mode of operation, client terminals 106-1-m may be referred to as sending client terminals or receiving client terminals. For example, a given client terminal 106-1-m may be referred to as a sending client terminal when operating to send a video stream to conferencing server 102. In another example, a given client terminal 106-1-m may be referred to as a receiving client terminal when operating to receive a video stream from conferencing server 102, such as a video stream from a sending client terminal, for example. In the various embodiments described below, client terminal 106-1 is described as a sending client terminal, while client terminals 106-2-m are described as receiving client terminals, by way of example only. Any of client terminals 106-1-m may operate as a sending or receiving client terminal throughout the course of conference call, and frequently shift between modes at various points in the conference call. The embodiments are not limited in this respect.

In various embodiments, multimedia conferencing system 100 may comprise, or form part of, a wired communications system, a wireless communications system, or a combination of both. For example, multimedia conferencing system 100 may include one or more elements arranged to communicate information over one or more types of wired media communications channels. Examples of a wired media communications channel may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. Multimedia conferencing system 100 also may include one or more elements arranged to communicate information over one or more types of wireless media communications channels. Examples of a wireless media communications channel may include, without limitation, a radio channel, infrared channel, radio-frequency (RF) channel, Wireless Fidelity (WiFi) channel, a portion of the RF spectrum, and/or one or more licensed or license-free frequency bands.

Multimedia conferencing system 100 also may be arranged to operate in accordance with various standards and/or protocols for media processing. Examples of media processing standards include, without limitation, the Society of Motion Picture and Television Engineers (SMPTE) 421M (“VC-1”) series of standards and variants, VC-1 implemented as MICROSOFT® WINDOWS® MEDIA VIDEO version 9 (WMV-9) series of standards and variants, Digital Video Broadcasting Terrestrial (DVB-T) broadcasting standard, the ITU/IEC H.263 standard, Video Coding for Low Bit rate Communication, ITU-T Recommendation H.263v3, published November 2000 and/or the ITU/IEC H.264 standard, Video Coding for Very Low Bit rate Communication, ITU-T Recommendation H.264, published May 2003, Motion Picture Experts Group (MPEG) standards (e.g., MPEG-1, MPEG-2, MPEG-4), and/or High performance radio Local Area Network (HiperLAN) standards. Examples of media processing protocols include, without limitation, Session Description Protocol (SDP), Real Time Streaming Protocol (RTSP), Real-time Transport Protocol (RTP), Synchronized Multimedia Integration Language (SMIL) protocol, and/or Internet Streaming Media Alliance (ISMA) protocol. The embodiments are not limited in this context.

In one embodiment, for example, conferencing server 102 and client terminals 106-1-m of multimedia conferencing system 100 may be implemented as part of an H.323 system operating in accordance with one or more of the H.323 series of standards and/or variants. H.323 is an ITU standard that provides specification for computers, equipment, and services for multimedia communication over networks that do not provide a guaranteed quality of service. H.323 computers and equipment can carry real-time video, audio, and data, or any combination of these elements. This standard is based on the IETF RTP and RTCP protocols, with additional protocols for call signaling, and data and audiovisual communications. H.323 defines how audio and video information is formatted and packaged for transmission over the network. Standard audio and video coders/decoders (codecs) encode and decode input/output from audio and video sources for communication between nodes. A codec converts audio or video signals between analog and digital forms. In addition, H.323 specifies T.120 services for data communications and conferencing within and next to an H.323 session. The T.120 support services means that data handling can occur either in conjunction with H.323 audio and video, or separately, as desired for a given implementation.

In accordance with a typical H.323 system, conferencing server 102 may be implemented as an MCU coupled to an H.323 gateway, an H.323 gatekeeper, one or more H.323 terminals 106-1-m, and a plurality of other devices such as personal computers, servers and other network devices (e.g., over a local area network). The H.323 devices may be implemented in compliance with the H.323 series of standards or variants. H.323 client terminals 106-1-m are each considered “endpoints” as may be further discussed below. The H.323 endpoints support H.245 control signaling for negotiation of media channel usage, Q.931 (H.225.0) for call signaling and call setup, H.225.0 Registration, Admission, and Status (RAS), and RTP/RTCP for sequencing audio and video packets. The H.323 endpoints may further implement various audio and video codecs, T.120 data conferencing protocols and certain MCU capabilities. Although some embodiments may be described in the context of an H.323 system by way of example only, it may be appreciated that multimedia conferencing system 100 may also be implemented in accordance with one or more of the IETF SIP series of standards and/or variants, as well as other multimedia signaling standards, and still fall within the scope of the embodiments. The embodiments are not limited in this context.

In general operation, multimedia conference system 100 may be used for multimedia conference calls. Multimedia conference calls typically involve communicating voice, video, and/or data information between multiple end points. For example, a public or private packet network may be used for audio conferencing calls, video conferencing calls, audio/video conferencing calls, collaborative document sharing and editing, and so forth. The packet network may also be connected to the PSTN via one or more suitable VoIP gateways arranged to convert between circuit-switched information and packet information. To establish a multimedia conference call over a packet network, each client terminal 106-1-m may connect to conferencing server 102 using various types of wired or wireless media communications channels 108-1-n operating at varying connection speeds or bandwidths, such as a lower bandwidth PSTN telephone connection, a medium bandwidth DSL modem connection or cable modem connection, and a higher bandwidth intranet connection over a local area network (LAN), for example.

Conferencing server 102 typically operates to coordinate and manage a multimedia conference call over a packet network. Conferencing server 102 receives a video stream from a sending client terminal (e.g., client terminal 106-1) and multicasts the video stream to multiple receiving client terminals participating in the conference call (e.g., receiving client terminals 106-2-m). During multicast operations, sometimes one or more video frames need from a video frame sequence need to be retransmitted for various reasons. For example, the data representing one or more video frames may be lost or corrupted during transmission over media communications channels 108-2-n. In this case, a receiving client terminal 106-2-n may request a resend of the lost video frame or entire video frame sequence from sending client terminal 106-1. Similarly, when a new receiving client terminal desires to join a conference call, the new receiving client terminal may request sending client terminal 106-1 to retransmit the latest key frame as well as the latest Super-P and P frames so the terminal can start decoding the most recent frames transmitted by server 102. Both scenarios may unnecessarily burden computing and memory resources for sending client terminal 106-1. Alternatively, the new receiving client terminal 106-2-4 may wait until sending client terminal 106-1 sends the next sequence of video frames. This solution potentially causes the new receiving client terminal 106-2-4 to experience various amounts of unnecessary delay when joining the conference call.

To solve these and other problems, various embodiments may implement techniques for distributed caching of video information for multimedia conference system 100 in order to facilitate retransmission of video frames in response to various retransmission events. Examples of retransmission events may include, but are not limited to, events such as lost or missing video frames due to data corruption or malfunction of the server 102, a new participant joining the conference call, a loss of frame synchronization or frame slip, dropped frames, receiver malfunction, and so forth. The embodiments are not limited in this context.

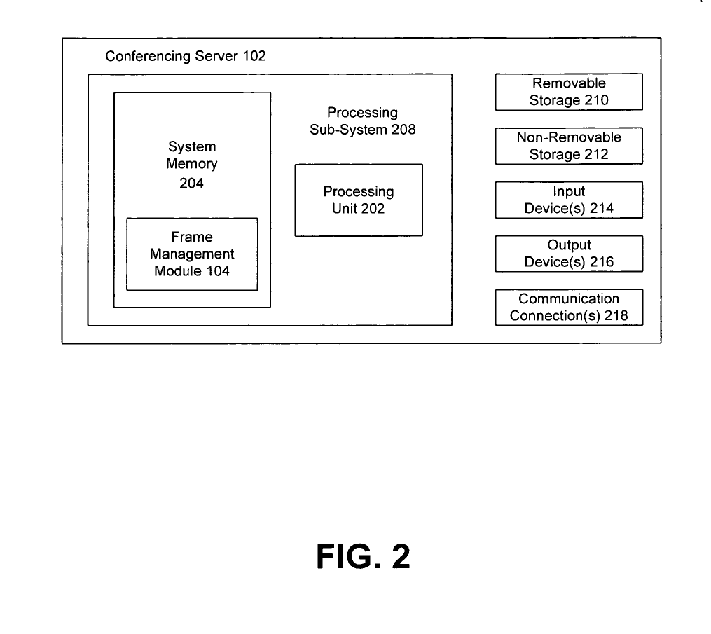

In various embodiments, conferencing server 102 and/or various receiving client terminals 106-2-n may include a frame management module 104. Frame management module 104 may be arranged to receive a client frame request for one of the video frames from a receiving client terminal 106-2-n. Frame management module 104 may retrieve the requested video frames, and send the requested video frames in response to the client frame request to the receiving client terminal that initiated the request. For example, frame management module 104 may retrieve the requested video frames from a local memory unit implemented with conferencing server 102 to store the latest video frame or sequence of video frames, or from another receiving client terminal 106-2-4 having memory units 110-2-4, respectively, to store the latest video frame or sequence of video frames. In this manner, retransmission operations may be performed by other elements of multimedia conferencing system 100 in addition to, or in lieu of, sending client terminal 106-1. In an extreme case, each client terminal 106-2-n , n>1, sends a subset of the video frames requested by terminal 106-2-1. Multimedia conferencing system 100 in general, and conferencing system 102 in particular, may be described with reference to FIG. 2.

FIG. 2 illustrates a more detailed block diagram of conferencing server 102. In its most basic configuration, conferencing server 102 typically includes a processing sub-system 208 that comprises at least one processing unit 202 and memory 204. Processing unit 202 may be any type of processor capable of executing software, such as a general-purpose processor, a dedicated processor, a media processor, a controller, a microcontroller, an embedded processor, a digital signal processor (DSP), and so forth. Memory 204 may be implemented using any machine-readable or computer-readable media capable of storing data, including both volatile and non-volatile memory. For example, memory 204 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 1, memory 204 may store various software programs, such as frame management module 104 and accompanying data. The software program 204 may have to be duplicated in the memory if it is designed to handle one media stream at a time. Likewise, processor 202 and frame management module 204 may be duplicated several times if the host system is a multi-core microprocessor-based computing platform. Memory 204 may also store other software programs to implement different aspects of conferencing server 102, such as various types of operating system software, application programs, video codecs, audio codecs, call control software, gatekeeper software, multipoint controllers, multipoint processors, and so forth. Alternatively such operations may be implemented in the form of dedicated hardware (e.g., DSP, ASIC, FPGA, and so forth) or a combination of hardware, firmware and/or software as desired for a given implementation. The embodiments are not limited in this context.

Conferencing server 102 may also have additional features and/or functionality beyond configuration 106. For example, conferencing server 102 may include removable storage 210 and non-removable storage 212, which may also comprise various types of machine-readable or computer-readable media as previously described. Conferencing server 102 may also have one or more input devices 214 such as a keyboard, mouse, pen, voice input device, touch input device, and so forth. One or more output devices 216 such as a display, speakers, printer, and so forth may also be included in conferencing server 102 as well.

Conferencing server 102 may further include one or more communications connections 218 that allow conferencing server 102 to communicate with other devices. Communications connections 218 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes both wired communications media and wireless communications media, as previously described. The terms machine-readable media and computer-readable media as used herein are meant to include both storage media and communications media.

In various embodiments, conferencing server 102 may include frame management module 104. Frame management module 104 may manage retransmission operations for conferencing server 102. The functions of the frame management module 104 are many. Its first responsibility is to decide which frames to cache and when to remove them the cache. Another responsibility of the management module 104 is to prioritize simultaneous requests for past video frames from multiple terminals. Yet another responsibility of the frame management module 104 is to schedule the time when each of these requests should be serviced. Also, it should be noted that frame management module 104 makes use of dedicated memory space to store the cached video frames. This memory space get cyclically refreshed as old video frame data are replaced by new incoming video frame data as the video conference goes on. Although some embodiments may illustrate frame management module 104 as implemented with conferencing server 102, it may be appreciated that frame management module 104 may be implemented with other elements of multimedia conferencing system 100, such as one or more receiving client terminals 106-2-n, to facilitate distributed caching and retransmission operations for multimedia conference system 100. The embodiments are not limited in this context.

Multimedia conferencing system 100 may need to retransmit video frames in a number of scenarios. For example, when the data representing a video frame is lost or corrupted, the video frame sequence is no longer valid and a video decoder will not be able to decode the video stream. The video frame sequence needs to be corrected prior to performing decoding operations. In another example, when a new receiving terminal joins an existing conference, the video stream may be at any point in a video frame sequence, such as an I-frame, P-frame, SP-frame or B-frame. Unless the first frame to the new person is an I-frame the rest of the video frames in the video frame sequence of the received video stream are not decodable. The conventional approach to such problems is to send a request to the sender of the video stream and request a new I-frame.

Various embodiments provide a technique to obtain the missing video frames from a source other than the sender of the video stream. In some embodiments, for example, the missing video frames may be obtained from conferencing server 102. Conferencing server 102 may store various amounts of video frames from a sending client terminal 106-1 in system memory 204 and/or memory units 210, 212. If a video frame is lost between conferencing server 102 and a receiving client terminal 106-2-n, then conferencing server 102 will have the video frame. Rather than conferencing server 102 sending a request to sending client terminal 106-1 when it receives a lost frame report, it can directly forward the frame again to the requesting receiving client terminal. If the video bitstream includes multiple spatial scales, conferencing server 102 may decide to send only the lowest scale or the lowest scales to reduce the amount of data transmitted to client terminal 106-1.

In some embodiments, the missing video frames or lower spatial and/or temporal representations of the missing video frames may also be obtained from one or more receiving client terminals 106-2-4 participating in the conference call. In some cases, caching the video frames for multiple conferences may consume significant amounts of memory for conferencing server 102. As an alternative to conferencing server 102 caching video frames in a local memory unit, a receiving client terminal such as receiving client terminal 106-2 could submit a request for the missing frames from another receiving client terminals 106-3-n participating in the conference call, such as client terminal 106-3, for example. Receiving client terminals 106-2-n may learn about the other receiving client terminals arranged to retransmit missing video frames from information received from conferencing server 102, or alternatively, by using multicast or other techniques to communicate to peers such as UPnP or other peer-to-peer protocols and/or control protocols.

To retransmit missing video frames, for example, receiving client terminal 106-3 may cache frames after it has rendered or decoded the frames in case another receiving client terminal such as receiving client terminal 106-2 submits a request for a given frame. Receiving client terminal 106-3 may cache certain video frames for a limited period of time, and thereby be capable of responding to requests for particular frames. The amount of time to store certain video frames may vary in accordance with a number of factors, such as policy/configuration settings, the type of video frames to store, a number of video frames to store, a dependency order or structure of a sequence of video frames, an amount of memory resources, memory access times, and so forth. The embodiments are not limited in this context.

Similarly, to support new receiving client terminals joining the conference, such as receiving client terminal 106-4, receiving client terminal 106-3 would need to cache frames from the last I-frame. Receiving client terminal 106-3 would respond to a join request from new receiving client terminal 106-4 with all the frames since the last I-frame including the last I-frame, for example. The response could provide the original video sequence or a lower spatial and temporal representation of the video sequence.

In some cases, the video frame cache may also be distributed among various receiving client terminals 106-2-n. For example, receiving client terminals 106-5, 106-6 may each cache a portion (e.g., a slice or a set of macroblocks) of a video frame sequence. A receiving client terminal that is missing a certain video frame may contact a receiving client terminal that caches the missing frame such as receiving client terminal 106-3, or multiple receiving client terminals caching portions of a video frame sequence such as receiving client terminals 106-5, 106-6, for example. A new receiving client terminal such as receiving client terminal 106-4 may therefore have the ability to contact one or more receiving client terminals to obtain all of the missing frames.

If the receiving client terminals are using multicast to request and obtain the missing frames, they can also use multicast to organize which receiving client terminals are caching which video frames. For example, if 10 receiving client terminals are able to communicate with each other via multicast, they can arrange to cache 1 out of every 5 video frames. This allows more than 1 receiving client terminal to cache a video frame in case one of the receiving client terminals leaves the conference call.

In various embodiments, one or more receiving client terminals could also multicast frames that they cache periodically whether another receiving client terminal requests a retransmission for the video frames or not. This allows receiving client terminals to obtain missing frames without sending a request for them. In addition, if a receiving client terminal is receiving all frames via multicast, it can signal to conferencing server 102 to stop sending it the video stream and obtain all the video frames from the caches of other receiving client terminals.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

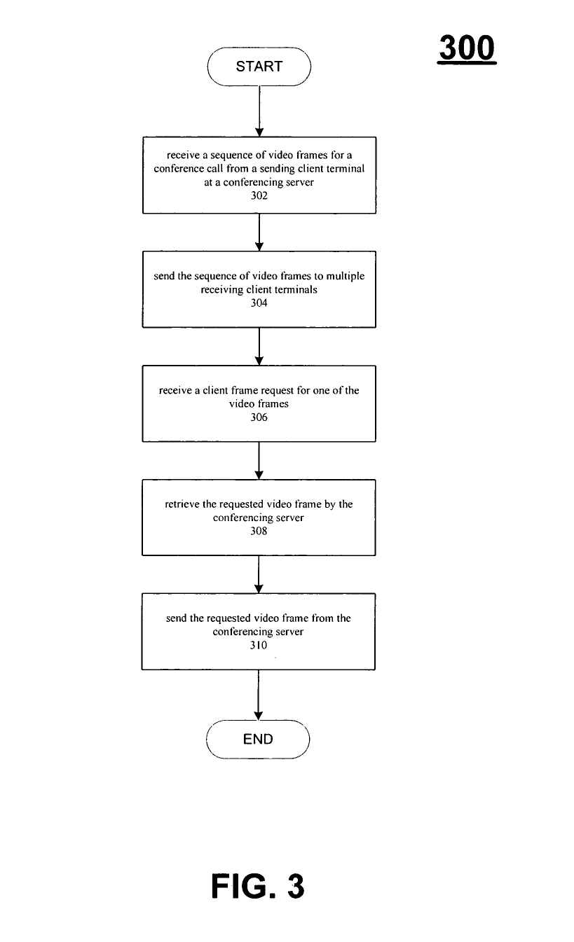

FIG. 3 illustrates one embodiment of a logic flow 300. Logic flow 300 may be representative of the operations executed by one or more embodiments described herein, such as multimedia conferencing system 100, conferencing server 102, and/or frame management module 104. As shown in FIG. 3, a sequence of video frames for a conference call from a sending client terminal may be received at a conferencing server at block 302. The sequence of video frames may be sent to multiple receiving client terminals at block 304. A client frame request for one of the video frames may be received at block 306. The requested video frame may be retrieved by the conferencing server at block 308. The requested video frame may be sent from the conferencing server at block 310. The embodiments are not limited in this context.

As illustrated in logic flow 300, conferencing server 102 may perform retransmission operations for data representing missing video frames sent by sending client terminal 106-1 without requesting sending client terminal 106-1 to resend the missing video frames. For example, conferencing server 102 may retrieve data representing the missing frames or data representing a lower resolution of the missing frames from its local memory, or from another receiving client terminal participating in the same conference call, to handle the retransmission request.

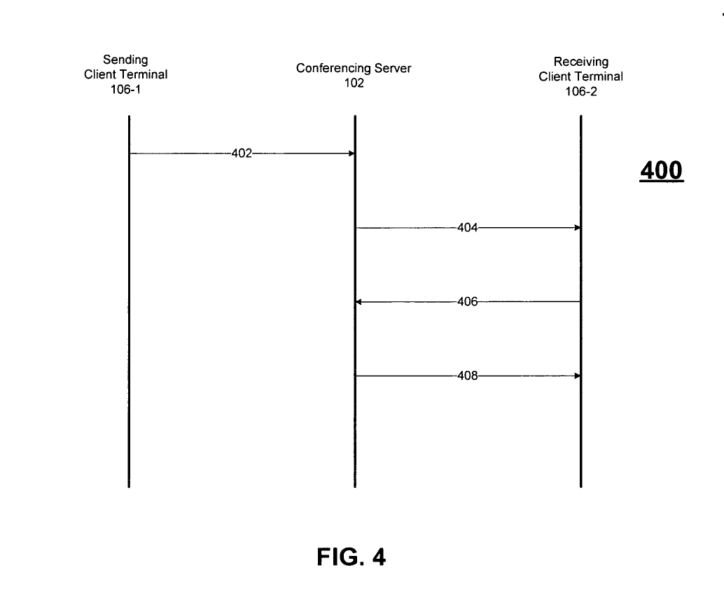

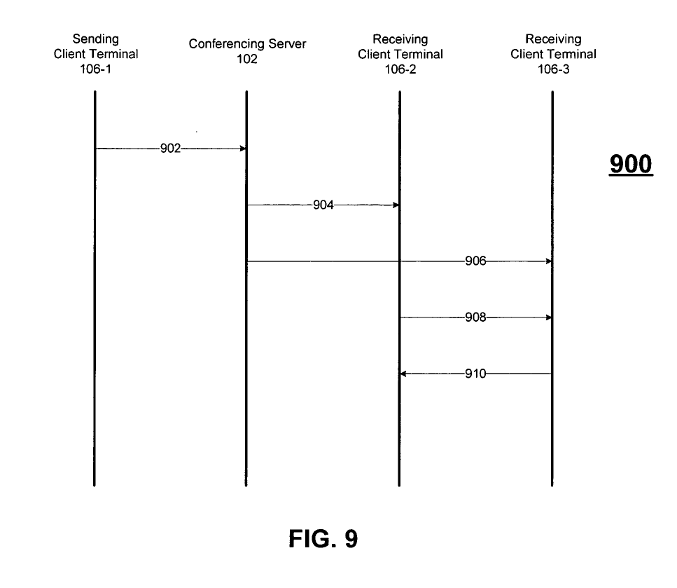

Retransmission operations may be facilitated by distributively caching data representing video frames in a compressed form from a video stream in memory units of various elements of multimedia conferencing system 100. For example, conferencing server 102 may store certain video frames received from sending client terminal 106-1 to respond to retransmission requests from various receiving client terminals. In another example, various receiving client terminals 106-2-n may store certain video frames received from sending client terminal 106-1 via conferencing server 102 to respond to retransmission requests from other receiving client terminals participating in the same conference call. The retransmission requests may be initiated by a receiving client terminal in response to any number of retransmission events as previously described, such as when a receiving client terminal fails to receive all of the video frames for a given video frame sequence (e.g., an I-frame), when a new receiving client terminal joins the conference call, and so forth. The retransmission requests may sometimes request, for example, an independent frame (I-frame) from the sequence of video frames used to decode one or more frames of the sequence of video frames, a decoded frame previously rendered by a receiving client terminal, or an entire video frame sequence or GOP. The type of permitted request has an impact on the types of frames stored by conference server 102 and/or endpoints 106-2-n. For example, if only I frames are requested, the type of video frames saved by server 102 or endpoints 106-2-n is only I frames. Various sets of retransmission operations as performed by conferencing server 102 may be described in more detail with reference to FIGS. 4-8, while retransmission operations performed by a given receiving client terminal may be described in more detail with reference to FIGS. 4-8 in general, and FIGS. 9-12 in particular.

FIG. 4 illustrates an exemplary embodiment of a first message flow. FIG. 4 illustrates a message flow 400 illustrating a first set of retransmission operations for conferencing server 102. More particularly, message flow 400 illustrates a message flow when a receiving client terminal 106-2 fails to receive one or more video frames in a video sequence, and conferencing server 102 handles retransmission operations using video frames stored in its local memory (e.g., memory units 204, 210 and/or 212).

As shown in FIG. 4, sending client terminal 106-1 may send a compressed video stream representing multiple groups of video frames (e.g., GOP structures), with each video frame sequence having multiple video frames of different types (e.g., I-frame, P-frame, SP-frame, B-frame, and so forth) as indicated by arrow 402. Conferencing server 102 may receive the video stream, and store data representing one or more of the most recent video frames in a circular local memory unit. Conferencing server 102 may forward the video stream from sending client terminal 106-1 to receiving client terminal 106-2 as indicated by arrow 404. First receiving client terminal 106-2 may receive the sequence of video frames, and detect that data representing one or more video frames from the video frame sequence are missing. First receiving client terminal 106-2 may send a client resend frame request for the missing video frames to sending client terminal 106-1 and/or conferencing server 102. Conferencing server 102 may receive a client resend frame request (e.g., implicitly or explicitly) from a first receiving client terminal 106-2 as indicated by arrow 406, and retrieve the stored video frame from the memory unit. Conferencing server 102 may send the stored video frame to first receiving client terminal 106-2 as indicated by arrow 408. First receiving client terminal 106-2 may receive the one or more stored video frames from conference server 102.

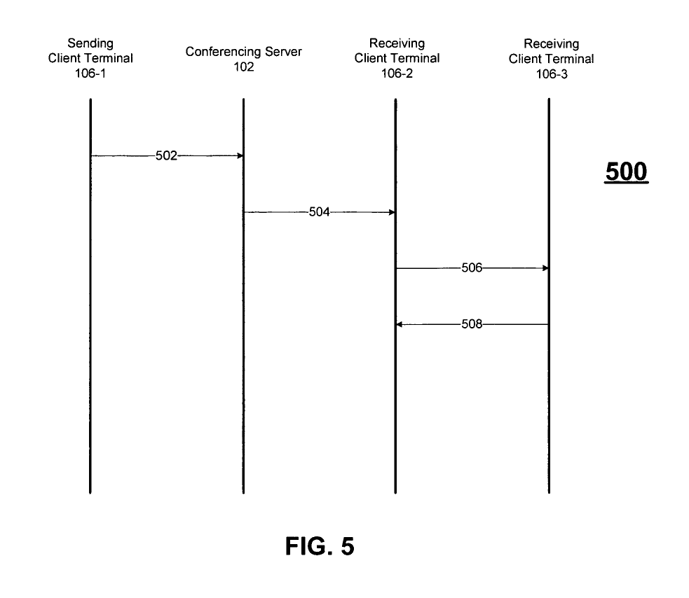

FIG. 5 illustrates an exemplary embodiment of a second message flow. FIG. 5 illustrates a message flow 500 illustrating a set of retransmission operations for conferencing server 102. More particularly, message flow 500 illustrates a message flow when a receiving client terminal 106-2 fails to receive one or more video frames in a video sequence, and video frames are stored by other receiving client terminals participating in the same conference call and such frames are used by other receiving clients to recover from packet loss.

As shown in FIG. 5, sending client terminal 106-1 sends a video stream to conferencing server 102 as indicated by arrow 502, and conferencing server 102 sends the video stream to first receiving client terminal 106-2 as indicated by arrow 504. In some cases, first receiving client terminal 106-2 may not receive all of the video frames data from the received video stream. Instead of requesting the missing video frames from sending client terminal 106-1, first receiving client terminal 106-2 may request data representing the missing video frames from another receiving client 106-3.

First receiving client terminal 106-2 may send a client resend frame request to second receiving client terminal 106-3 as indicated by arrow 506. Since second receiving client terminal 106-3 is participating in the same conference call with first receiving client terminal 106-2, second receiving client terminal 106-3 has been receiving the same video stream as first receiving client terminal 106-2. In various embodiments, second receiving client terminal 106-3 may store certain video frames from the video stream in memory 110-3. Second receiving client terminal 106-3 receives the resend frame request from client terminal 106-2, retrieves the requested missing video frames from memory 110-3, and sends the stored video frames to client terminal 106-2 that needs the video frames as indicated by arrow 508.

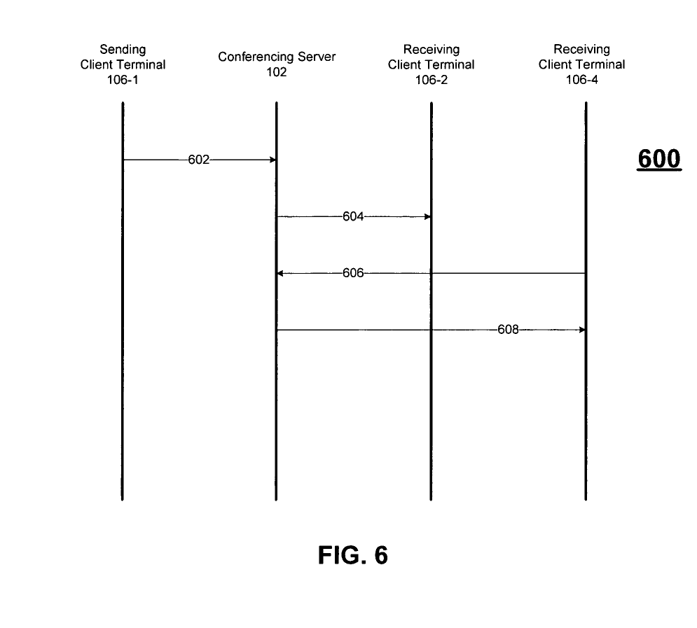

FIG. 6 illustrates an exemplary embodiment of a third message flow. FIG. 6 illustrates a message flow 600 illustrating a third set of retransmission operations for conferencing server 102. More particularly, message flow 600 illustrates a message flow when a new receiving client terminal attempts to join an existing conference call between client terminals 106-1, 106-2, and conferencing server 102 handles retransmission operations using video frames stored in its local memory (e.g., memory units 204, 210 and/or 212).

As shown in FIG. 6, sending client terminal 106-2 may send a video stream to conferencing server 102 as indicated by arrow 602. Conferencing server 102 may forward the video stream to receiving client terminal 106-2 as indicated by arrow 604. Assume a third receiving client terminal 106-4 desires to join the conference call between client terminals 106-1, 106-2. Third receiving client terminal 106-4 may send a client join request to conferencing server 102 to join the existing conference call. With the client join request, or separate from the client join request, third receiving client terminal 106-4 may send a client join frame request to conferencing server 102 as indicated by arrow 606. Conferencing server 102 may retrieve some or all of the sequence of video frames from its local memory, and send the retrieved video frames to third receiving client terminal 106-4 as indicated by arrow 608. Third receiving client terminal 106-4 may receive the video frames from conference server 102. An example scenario is server 102 sending the set of I, SP and P frames necessary for receiving client terminal 106-4 to start decoding and displaying video frames when such frames are not at the beginning of a GOP. The overall effect is to reduce tuning latency.

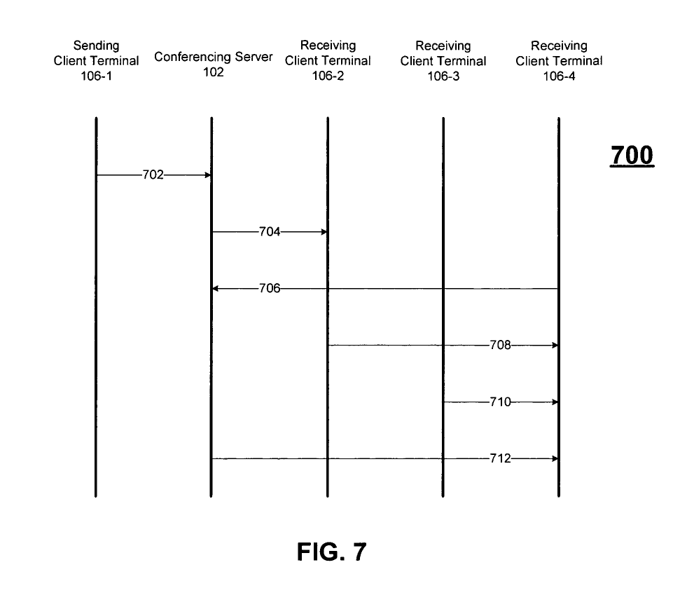

FIG. 7 illustrates an exemplary embodiment of a fourth message flow. FIG. 7 illustrates a message flow 700 illustrating a fourth set of retransmission operations for conferencing server 102. More particularly, message flow 700 illustrates a message flow when a new receiving client terminal attempts to join an existing conference call between client terminals 106-1, 106-2, and video frames are stored by other receiving client terminals participating in the same conference call and such stored video frames are retrieved by other receiving clients who have experienced loss of packets representing all or a portion of these frames.

As shown in FIG. 7, sending client terminal 106-1 may send a video stream to conferencing server 102 as indicated by arrow 702. Conferencing server 102 may send the video stream to receiving client terminal 106-2 as indicated by arrow 704. Conferencing server 102 may receive a client join frame request from a third receiving client terminal 106-4 as indicated by arrow 706. Client terminal 106-4 has a predetermined schedule to contact either receiving client terminal 106-2 and/or receiving client 106-3 and request the video frames needed. The schedule may be determined from the position of the frames needed in the GOP. Client terminals 106-2 and/or 106-3 send the missing video frames to client terminal 106-4 who can start decoding and displaying video. As an example, client terminal 106-2 may hold the latest I and SP frames and client terminal 106-3 may hold the latest P frames. Both client terminals 106-2, 106-3 supply I, SP and P frames to client terminal 106-4 to enable the client to decode and display meaningful video quickly as indicated by respective arrows 708, 710. The role of each client may be assigned by the server before the conference is started. Past this initialization phase, client terminal 106-4 may receive the subsequent video frames from conference server 102 as any other receiver client as indicated by arrow 712.

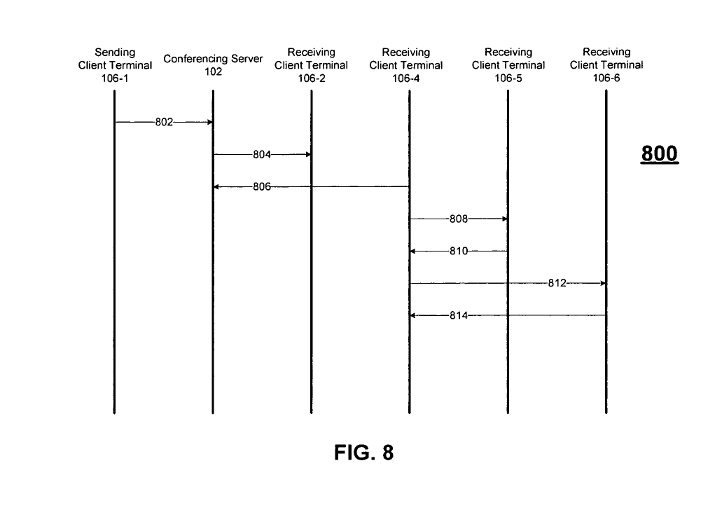

FIG. 8 illustrates an exemplary embodiment of a fifth message flow. FIG. 8 illustrates a message flow 800 illustrating a fifth set of retransmission operations for conferencing server 102. More particularly, message flow 800 illustrates a message flow when a new receiving client terminal attempts to join an existing conference call between client terminals 106-1, 106-2, and video frames stored by other multiple receiving client terminals participating in the same conference call are delivered directly to the new participant. This message flow provides an example of distributed caching of video frames among multiple receiving client terminals 106-2-n.

Message flow 800 illustrates an example of distributed caching of video frames across multiple receiving client terminals 106-2-n. As shown in FIG. 8, sending client terminal 106-1 may send a video stream to conferencing server 102 as indicated by arrow 802. Conferencing server 102 may reflect the video stream to receiving client terminal 106-2 as indicated by arrow 804. Assume a third receiving client terminal 106-4 desires to join the conference call between client terminals 106-1, 106-2. Third receiving client terminal 106-4 may send a join request to conferencing server 102 as indicated by arrow 806. In combination with the join request, or separate from the join request, third receiving client terminal 106-4 may send a client join frame request to receiving client terminal 106-5 as indicated by arrow 808.

Conferencing server 102 may handle the client join frame request from third receiving client terminal 106-4 by retrieving the requested video frames from caches maintained by multiple receiving client terminals. A first portion of the video may be received from client 106-5 as indicated by arrow 810. Similarly, third receiving client terminal 106-4 may send a client join frame request to fourth receiving client terminal 106-6 as indicated by arrow 812, and receive a second portion of the video frames from fourth receiving client terminal 106-6 as indicated by arrow 814,.

FIG. 9 illustrates an exemplary embodiment of a sixth message flow. FIG. 9 illustrates a message flow 900 illustrating a sixth set of retransmission operations for a receiving client terminal caching one or more video frames in accordance with the distributed caching technique. More particularly, message flow 900 illustrates a message flow when a first receiving client terminal 106-2 fails to receive one or more video frames in a video sequence, and a second receiving client terminal 106-3 handles retransmission operations using video frames stored in its local memory 110-3. In this exemplary message flow, frame management module 104 may be implemented as part of second receiving client terminal 106-3 to manage retransmission operations on behalf of second receiving client terminal 106-3.

As shown in FIG. 9, sending client terminal 106-1 may send a video stream to conferencing server 102 as indicated by arrow 902. Conferencing server 102 may send the video stream to first receiving client terminal 106-2 as indicated by arrow 904, and second receiving client terminal 106-3 as indicated by arrow 906. In this manner, receiving client terminals 106-2, 106-3 should receive the same video information for the conference call. Assume second receiving client terminal 106-3 stores a portion of the received video information in memory 110-3. Further assume that first receiving client terminal 106-2 is missing one or more video frames from the video frame sequence received by second receiving client terminal 106-3. First receiving client terminal 106-2 may send a client frame request to second receiving client terminal 106-3 to request the missing video frames as indicated by arrow 908. Second receiving client terminal 106-3 may receive the client frame request for the missing video frames from first receiving client terminal 106-2, retrieve the missing video frames from memory 110-3, and send the missing video frames to first receiving client terminal 106-2 as indicated by arrow 910. First receiving client terminal 106-2 may receive the stored video frames from second receiving client terminal 106-3 and begin decoding operations.

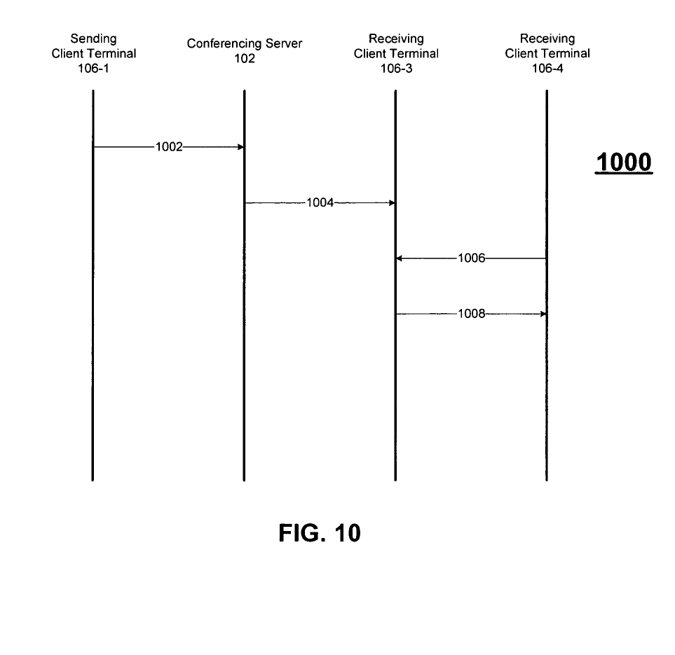

FIG. 10 illustrates an exemplary embodiment of a seventh message flow. FIG. 10 illustrates a message flow 1000 illustrating a seventh set of retransmission operations for a receiving client terminal caching one or more video frames in accordance with the distributed caching technique. More particularly, message flow 1000 illustrates a message flow when a third receiving client terminal 106-4 desires to join an existing conference call between client terminals 106-1-3, and second receiving client terminal 106-3 handles retransmission operations to facilitate joining and decoding operations for third receiving client terminal 106-4 using video frames stored in its local memory 110-3.

As shown in FIG. 10, sending client terminal 106-1 may send a video stream to conferencing server 102 as indicated by arrow 1002. Conferencing server 102 may forward the video stream to second receiving client terminal 106-3 as indicated by arrow 1004. Second receiving client terminal 106-3 may store a portion of the video stream in memory 110-3. Second receiving client terminal 106-3 may receive a client join frame request from a third receiving client terminal 106-4 as indicated by arrow 1006. Second receiving client terminal 106-3 may retrieve one or more video frames from the sequence of video frames requested with the client join frame request from memory 110-3, and send the retrieved video frames to third receiving client terminal 106-4 as indicated by arrow 1008. Third receiving client terminal 106-4 may receive the requested video frames from second receiving client terminal 106-3, and begin decoding operations of other received video frames in the same video frame sequence from conferencing server 102 to join the existing conference call. In this manner, third receiving client terminal 106-4 may join the existing conference call at any point in a given video frame sequence since it may receive an I-frame or decoded frame from second receiving client terminal 106-3 needed to decode the other dependent frames within the same video frame sequence.

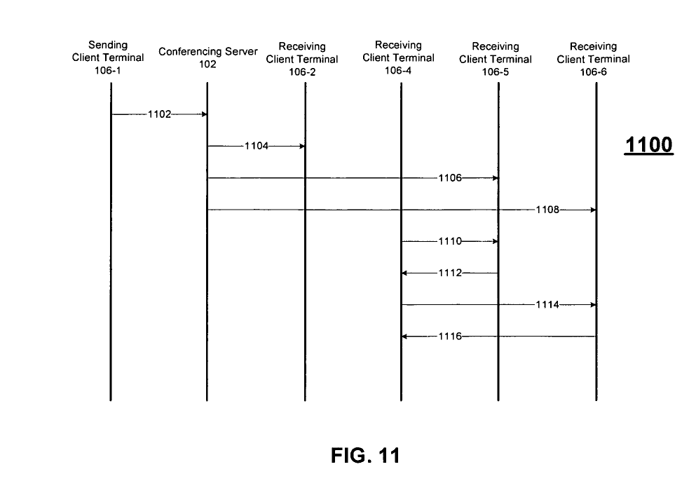

FIG. 11 illustrates an exemplary embodiment of an eighth message flow. FIG. 11 illustrates a message flow 1100 illustrating an eighth set of retransmission operations for multiple receiving client terminals caching various video frames in accordance with the distributed caching technique. More particularly, message flow 1100 illustrates a message flow when a third receiving client terminal 106-4 desires to join an existing conference call between client terminals 106-1-3, and third receiving client terminal 106-4 requests video information from multiple receiving client terminals participating in the existing conference call to facilitate joining and decoding operations for third receiving client terminal 106-4 using video frames cached in their respective memory units.

As shown in FIG. 11, sending client terminal 106-1 may send a video stream to conferencing server 102 as indicated by arrow 1102. Conferencing server 102 may send the video stream to receiving client terminals 106-2, 106-5 and 106-6 as indicated by arrows 1104, 1106 and 1108, respectively. Assume a fourth receiving client terminal 106-5 stores a first portion of the sequence of video frames in memory 110-5, and a fifth receiving client terminal 106-6 stores a second portion of the sequence of video frames in memory 110-6. Further assume a third receiving client terminal 106-4 desires to join an existing conference call between receiving client terminals 106-1, 106-2, 106-5 and 106-6. Third receiving client terminal 106-4 may send a client join request to conferencing server 102. Third receiving client terminal 106-4 may also send a first client join frame request to fourth receiving client terminal 106-5 for the first portion as indicated by arrow 1110, and a second client join frame request to fifth receiving client terminal 106-6 for the second portion as indicated by arrow 1114. Receiving client terminals 106-5, 106-6 may each, respectively, receive the first and second client join frame requests, retrieve the first and second portions, and independently or jointly send the first and second portions to third receiving client terminal 106-4 as indicated by arrows 1112, 1116. Alternatively, a different receiving client terminal (e.g., 106-3) may coordinate retrieving the various portions of video frames from distributed caches maintained by receiving client terminals 106-5, 106-6, receive the various portions at receiving client terminal 106-3, and send the received portions from receiving client terminal 106-3 to third receiving client terminal 106-4. Third receiving client terminal 106-4 may receive the first and second portions, and begin decoding operations for the existing conference call.

Although some embodiments may retransmit the same encoding in response to a resend or join request, other embodiments may not necessarily need to retransmit the same encoding when a frame is retransmitted. For example, the first time a particular frame is transmitted from conferencing server 102, it might be encoded as a full resolution P-frame. The next time it is transmitted (e.g., in response to a request for a retransmission), conferencing server 102 may transmit the encoding for an I-frame, or any other representation that allows the client terminal 106 to reconstruct exactly or approximately an internal state adequate for further decoding. For example, if n frames are missing in a row, then it may be adequate to retransmit nothing for the first n-1 frames, and send an I-frame for the n'th frame. Similarly, if the purpose of the retransmission is to get the decoder back on track after multiple losses, it may be adequate to send a full or partial representation of the desired decoder state. The same frame encodings do not necessarily need to be retransmitted all over again. Similarly, it may be adequate to send a lower or higher spatio-temporal resolution encoding of the missing frame(s), as previously described. Consequently, some embodiments may send an encoded frame that is different from the requested frame itself. Further, the differently encoded frame can come in various forms, which can differ each time the frame is transmitted. The embodiments are not limited in this context.

In one embodiment, for example, conferencing server 102 may receive video frames from sending client 106-1. Conferencing server 102 may send the video frames to multiple receiving client terminals 106-2-6. Conferencing server 102 may receive a client frame request for one of the transmitted video frames, such as from a receiving client terminal having a missing or corrupted video frame. Conferencing server 102 may send reconstructing information in response to the client frame request.

In various embodiments, the reconstructing information may be any data or any other representation that allows a client terminal to reconstruct exactly or approximately an internal state adequate for further media processing or decoding. For example, the reconstructing information may comprise a different video frame (e.g., an I-frame) from the requested video frame (e.g., a P-frame). In another example, the reconstructing information may comprise the requested video frame. In yet another example, the reconstructing information may comprise an internal decoder state, such as an internal decoder state sufficient to begin or re-establish media processing and/or decoding. In still another example, the reconstructing information may comprise a different video frame from a sequence of video frames (e.g., GOP) containing the requested video frame. In yet another example, the reconstructing information may comprise a different video frame having a higher spatio-temporal resolution than the requested video frame. In still another example, the reconstructing information may comprise a different video frame having a lower spatio-temporal resolution than the requested video frame. It may be appreciated that these are merely a few example of reconstructing information, and others may be utilized and still fall within the scope of the embodiments.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, computing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving a sequence of video frames for a conference call from a sending client terminal at a conferencing server;
sending said sequence of video frames to multiple receiving client terminals;
receiving a client frame request for one of said video frames;
retrieving said requested video frame by said conferencing server; and
sending said requested video frame from said conferencing server.

2. The method of claim 1, comprising:
storing one or more of said video frames in memory at said conferencing server;
receiving a client resend frame request from a first receiving client terminal;
retrieving said stored video frame from said memory; and
sending said stored video frame to said first receiving client terminal.

3. The method of claim 1, comprising:
receiving a client resend frame request from a first receiving client terminal;
sending a server frame resend request for said stored video frame to a second receiving client terminal;
receiving said stored video frame from said second receiving client terminal; and
sending said stored video frame to said first receiving client terminal.

4. The method of claim 1, comprising:
storing one or more of said video frames in memory at said conferencing server;
receiving a client join frame request from a third receiving client terminal;
retrieving said sequence of video frames from said memory; and
sending said sequence of video frames to said third receiving client terminal.

5. The method of claim 1, comprising:
receiving a client join frame request from a third receiving client terminal; and
sending said sequence of video frames from a second receiving client terminal to said third receiving client terminal based on a schedule.

6. The method of claim 1, comprising:
receiving a client join frame request from a third receiving client terminal; and
sending a first portion of said sequence of video frames from a fourth receiving client terminal, and a second portion of said sequence of video frames from a fifth receiving client terminal, to said third receiving client terminal based on a schedule.

7. A method, comprising:
receiving a sequence of video frames for a conference call from a conference server at a first receiving client terminal;
sending a client resend frame request for one or more video frames from said sequence of video frames; and
receiving said one or more video frames from said conference server or a second receiving client terminal in said conference call.

8. The method of claim 7, comprising sending a client resend frame request for an independent frame from said sequence of video frames used to decode one or more frames of said sequence of video frames.

9. The method of claim 7, comprising sending a client resend frame request for a decoded frame from said sequence of video frames used to decode one or more frames of said sequence of video frames.

10. A method, comprising:
sending a client join request to a conference server to join a conference call between a sending client terminal, a first receiving client terminal, and a second receiving client terminal, from a third receiving client terminal;
sending a client join frame request to receive a sequence of video frames for said conference call from said third receiving client terminal; and
receiving said sequence of video frames from said conference server or a receiving client terminal.

11. The method of claim 10, comprising receiving said sequence of video frames from said first receiving client terminal or said second receiving client terminal.

12. The method of claim 10, comprising receiving a first portion of said sequence of video frames from a fourth receiving client terminal and a second portion of said sequence of video frames from a fifth receiving client terminal.

13. A method, comprising:
receiving a sequence of video frames from a conferencing server at a first receiving client terminal and a second receiving client terminal;
storing one or more of said video frames at said second receiving client terminal;
receiving a frame request for said one or more stored video frames; and
sending said one or more stored video frames from said second receiving client terminal.

14. The method of claim 13, comprising:
receiving a server resend frame request from said conferencing server at said second receiving client terminal; and
sending said one or more stored video frames from said second receiving client terminal to said conferencing server.

15. The method of claim 13, comprising:
receiving a client resend frame request from said first receiving client terminal at said second receiving client terminal; and
sending said one or more stored video frames from said second receiving client terminal to said first receiving client terminal.

16. The method of claim 13, comprising:
receiving a client join frame request from a third receiving client terminal at said second receiving client terminal; and
sending said sequence of video frames from said second receiving client terminal to said third receiving client terminal.

17. The method of claim 13, comprising:
receiving said sequence of video frames from said conferencing server at a fourth receiving client terminal and a fifth receiving client terminal;
storing a first portion of said sequence of video frames by a first memory unit for said fourth receiving client terminal and a second portion of said sequence of video frames by a second memory unit for said fifth receiving client terminal;
receiving a first client join frame request for said first portion from a third client terminal at said fourth receiving client terminal, and a second client join frame request for said second portion from said third client terminal at said fifth receiving client terminal; and
sending said first portion from said fourth receiving client terminal, and said second portion from said fifth receiving client terminal, to said third receiving client terminal.

18. An apparatus, comprising:
a conferencing server to receive a sequence of video frames from a sending client terminal and send said sequence of video frames to multiple receiving client terminals; and
a frame management module to receive a client frame request for one of said video frames from a receiving client terminal, retrieve said requested video frame, and send said requested video frame in response to said client frame request.

19. The apparatus of claim 20, comprising a memory to store one or more of said video frames, said frame management module to receive a client resend frame request from a first receiving client terminal, retrieve said stored video frame from said memory, and send said stored video frame to said first receiving client terminal.

20. The apparatus of claim 20, said frame management module to receive a client resend frame request from a first receiving client terminal, retrieve said stored video frame from a second receiving client terminal, and send said stored video frame to said first receiving client terminal.

21. The apparatus of claim 20, comprising a memory to store one or more of said video frames, said frame management module to receive a client join frame request from a third receiving client terminal, retrieve said sequence of video frames from said memory, and send said sequence of video frames to said third receiving client terminal.

22. An article comprising a machine-readable storage medium containing instructions that if executed enable a system to:
receive a sequence of video frames for a conference call from a sending client terminal at a conferencing server;
send said sequence of video frames to multiple receiving client terminals;
receive a client frame request for one of said video frames;
retrieve said requested video frame by said conferencing server; and
send said requested video frame from said conferencing server.

23. The article of claim 22, said machine-readable storage medium comprising a processing device, a computer-readable medium, a communications medium, or a propagated signal.

24. The article of claim 22, further comprising instructions that if executed enable the system to:
store one or more of said video frames in memory at said conferencing server;
receive a client resend frame request from a first receiving client terminal;
retrieve said stored video frame from said memory; and
send said stored video frame to said first receiving client terminal.

25. The article of claim 22, further comprising instructions that if executed enable the system to:
store one or more of said video frames in memory at said conferencing server;
receive a client join frame request from a third receiving client terminal;
retrieve said sequence of video frames from said memory; and
send said sequence of video frames to said third receiving client terminal.

26. An article comprising a machine-readable storage medium containing instructions that if executed enable a system to:
receive a sequence of video frames for a conference call from a conference server at a first receiving client terminal;
send a client resend frame request for one or more video frames from said sequence of video frames; and
receive said one or more video frames from said conference server or a second receiving client terminal in said conference call.

27. The article of claim 26, further comprising instructions that if executed enable the system to send a client resend frame request for an independent frame from said sequence of video frames used to decode one or more frames of said sequence of video frames.

28. The article of claim 26, further comprising instructions that if executed enable the system to send a client resend frame request for a decoded frame from said sequence of video frames used to decode one or more frames of said sequence of video frames.

29. An article comprising a machine-readable storage medium containing instructions that if executed enable a system to:
send a client join request to a conference server to join a conference call between a sending client terminal, a first receiving client terminal, and a second receiving client terminal, from a third receiving client terminal;
send a client join frame request to receive a sequence of video frames for said conference call from said third receiving client terminal; and
receive said sequence of video frames from said conference server or a receiving client terminal.

30. The article of claim 29, further comprising instructions that if executed enable the system to receive said sequence of video frames from said first receiving client terminal or said second receiving client terminal.

31. The article of claim 29, further comprising instructions that if executed enable the system to receive a first portion of said sequence of video frames from a fourth receiving client terminal and a second portion of said sequence of video frames from a fifth receiving client terminal.

32. An article comprising a machine-readable storage medium containing instructions that if executed enable a system to:
receive a sequence of video frames from a conferencing server at a first receiving client terminal and a second receiving client terminal;
store one or more of said video frames at said second receiving client terminal;
receive a frame request for said one or more stored video frames; and
send said one or more stored video frames from said second receiving client terminal.

33. The article of claim 32, further comprising instructions that if executed enable the system to:
receive a client resend frame request from said first receiving client terminal at said second receiving client terminal; and
send said one or more stored video frames from said second receiving client terminal to said first receiving client terminal.

34. The article of claim 32, further comprising instructions that if executed enable the system to:
receive a server join frame request from said conferencing server at said second receiving client terminal; and
send said sequence of video frames from said second receiving client terminal to said conferencing server.

35. The article of claim 32, further comprising instructions that if executed enable the system to:
receive a client join frame request from a third receiving client terminal at said second receiving client terminal; and
send said sequence of video frames from said second receiving client terminal to said third receiving client terminal.

36. The article of claim 32, further comprising instructions that if executed enable the system to:
receive said sequence of video frames from said conferencing server at a fourth receiving client terminal and a fifth receiving client terminal;
store a first portion of said sequence of video frames by a first memory unit for said fourth receiving client terminal and a second portion of said sequence of video frames by a second memory unit for said fifth receiving client terminal;
receive a first client join frame request for said first portion from a third client terminal at said fourth receiving client terminal, and a second client join frame request for said second portion from said third client terminal at said fifth receiving client terminal; and
send said first portion from said fourth receiving client terminal, and said second portion from said fifth receiving client terminal, to said third receiving client terminal.

37. A method, comprising:
receiving video frames for a conference call at a conferencing server;
sending said video frames to multiple receiving client terminals;
receiving a client frame request for one of said video frames; and
sending reconstructing information from said conferencing server in response to said client frame request.

38. The method of claim 37, said reconstructing information comprising a different video frame from said requested video frame.

39. The method of claim 37, said reconstructing information comprising said requested video frame.

40. The method of claim 37, said reconstructing information comprising an internal decoder state.

41. The method of claim 37, said reconstructing information comprising a different video frame from a sequence of video frames containing said requested video frame.

42. The method of claim 37, said reconstructing information comprising a different video frame having a higher spatio-temporal resolution than said requested video frame.

43. The method of claim 37, said reconstructing information comprising a different video frame having a lower spatio-temporal resolution than said requested video frame.
